(19) United States
(12) Patent Application Publication
(10) Pub. No.: US 2005/0195711 A1
(43) Pub. Date: Sep. 8, 2005

(54) Optical storage device and method for data recording

(75) Inventor: Kuo-Chun Lee, Taoyuan (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/072,656

(22) Filed: Mar. 4, 2005

(30) Foreign Application Priority Data
Mar. 5, 2004 (TW) 93105825

(51) Int. Cl. G11B 5/09

(52) U.S. Cl. 369/47.53; 369/53.26

(57) ABSTRACT

A method for data recording in a data area of an optical storage medium. The method determines a start position of the data area for data recording, determines a test position of the data area according to the start position, performs an optimum power calibration (OPC) procedure to determine an optimum laser power level for the test position, and writes data from the start position using the optimum laser power level.

### BACKGROUND OF THE INVENTION

1. Field of the Invention

The present invention relates to optical recording technology, and more particularly, to an optical storage device and method for optimal power calibration (OPC).

2. Description of the Related Art

Before the first bytes of data are recorded to an optical storage medium, an optical storage device must perform several calibration procedures to ensure that data is recorded at the optimum power and the highest quality. The characteristics of the dye on an optical storage medium may change with variations in ambient temperature and humidity, or there may be changed in dye thickness or variations in different dye batches, even from the same optical storage media manufacturer. In addition, the characteristics of the dye thereon may change after numerous writings. The deposition of the reflective coating may not be completely uniform. The sensitivity of the recording laser may vary over the surface of the optical storage medium and may change as the optical storage medium and drive age. The surface of the storage medium may be microscopically uneven or the optical storage medium may be unbalanced and wobble, or the hub may be off center causing the optical storage medium to be eccentric. Conventionally, an optical storage device determines a best write strategy, such as a laser waveform and a laser power, corresponding to a particular optical storage medium prior to each recording session. Therefore, optimum power control (OPC) is performed to determine a best laser power for a recording session.

FIG. 1 is a schematic diagram of a conventional optical storage medium. The conventional optical storage medium 1 is a disc with a center hole 5. The disc comprises a system area 30 and an information area 40. The system area 30 contains a program memory area (PMA) 10 and a power calibration area (PCA) 20 for determination of the proper laser power for each recording session. The PCA 20 contains a count area and a test area. The test area has 100 numbered partitions, and each partition is 15 frames long. These frames can be recorded with uniform samples of equal numbers of ones and zeroes, in fixed-time intervals with each frame recorded at a different laser power. If a laser reads the indicated power value from the disc as 6 milliwatts, it will, for example, then record in the test area using a power range between 4 milliwatts and 8 milliwatts. The optical storage drive, for example, uses the 15 frames of each test area partition to write 15 ‘blocks’ of data at 15 different laser power settings, seven stages above the optimum value, and seven stages below. For a recommended optimum power of 5.9 mW (read from the blank disc), for example, the 15 test recordings may be 4.1, 4.4, 4.6, 4.9, 5.1, 5.4, 5.6, 5.9, 6.2, 6.4, 6.7, 6.9, 7.2, 7.4, and 7.7 mW. The sample recordings are read back by the lower-power reading laser, for example, at about 0.5 milliwatts, and are then compared for reflectivity. The count area also has 100 numbered partitions. Each partition is one frame long and corresponds to a partition in the test area. Before power calibration is performed in the test area, one of the count area frames is recorded with random data at the indicated laser power level. The recorder keeps count of the number of frames that are not written for determining where the next test operation will be performed. The information area 40 contains a lead-in area 42, a data area 44 for data storage, and a lead-out area 46.

The conventional OPC procedure suffers from several limitations, particularly for optical read/write storage media, such as CD-RWS, DVD-RWs, DVD+RWs, or other similar media. The deposition of the reflective coating in the PCA and the program area may not be completely uniform. In addition, after a number of recordings, the dye properties of the PCA always varies from that of the data area. Thus, an incorrect determination of optimum laser power level may occur for a particular recording session. In view of the above limitations, a need exists for an optical storage device and method with improved OPC accuracy.

### SUMMARY OF THE INVENTION

It is therefore an object of the present invention to provide an optical storage device and method with improved optimum power calibration (OPC) accuracy.

The present invention discloses an exemplary method for recording data to a data area of an optical storage medium. The method determines a start position of the data area for data recording, determines a test position according to the start position, performs an optimum power calibration (OPC) procedure to determine an optimum laser power level for the test position, and writes data to the start position using the optimum laser power level.

Preferably, the method further comprises the following steps. The method writes multiple test samples from the test position using various test laser power levels, reads the test samples and determines the laser power level according to the read results of the test samples. The method additionally generates a writing strategy comprising a laser waveform and the laser power level, according to the read results of the test samples.

In one example, the optical storage medium comprises an information area (such as PMA on a CD, RMD on a −DVD, TOC on a +DVD and the like) storing a first number corresponding to the start position. The method further reads the first number as the start position. In another example, the optical storage medium comprises an information area (such as PMA on a CD, RMD on a −DVD, TOC on a +DVD and the like) storing a first number corresponding to the start position, and a second number corresponding to an end position, and the test position is located between the start position and the end position. In a third example, the test position is the start position.

A machine-readable storage medium is further provided to store a computer program which when executed performs the above method.

The prevent invention discloses another exemplary method for recording data in a recording session of an optical storage medium. The method writes multiple test samples to a recording session of a data area, reads the test samples, determines an optimum laser power level according to the read results of the test samples, erases the test samples from the recording session, and writes data to the recording session using the optimum laser power level.

Preferably, the optical storage medium comprises an information area (such as PMA on a CD, RMD on a −DVD, TOC on a +DVD and the like) storing address data corresponding to the recording session. The method further reads the address data from the information area. A machine-readable storage medium is further provided to store a computer program which when executed performs the above method.

The present invention discloses an exemplary optical storage device for recording data in a data area of an optical storage medium. The optical storage device comprises an optical read/write head and a processing unit. The optical read/write head reads data from the optical storage medium and writes data in the optical storage medium. The processing unit couples to the optical read/write head, determines a start position of the data area, determines a test position of the data area according to the start position, and performs an optimum power calibration (OPC) procedure to determine an optimum laser power level.

In one example, the optical storage medium comprises an information area (such as PMA on a CD, RMD on a −DVD, TOC on a +DVD and the like) storing a first number corresponding to the start position of the data area. The processing unit further directs the optical read/write head to read the first number as the start position. In another example, the optical storage medium comprises an information area (such as PMA on a CD, RMD on a −DVD, TOC on a +DVD and the like) storing a first number corresponding to the start position, and a second number corresponding to an end position, and the test position is located between the start position and the end position. In a third example, the test position is the start position.

Preferably, the processing unit directs the optical read/write head to write multiple test samples from the test position using various test laser power levels and read the test samples. The processing unit additionally determines the optimum laser power level according to the read results of the test samples.

The present invention discloses another exemplary optical storage device for recording data to a recording session of an optical storage medium. The optical storage device comprises an optical read/write head and a processing unit. The optical read/write head is configured to write multiple test samples in the recording session of a data area and read the test samples. The processing unit couples to the optical read/write head, determines an optimum laser power level according to the read results of the test samples, erases the test samples from the recording session, and directs the optical read/write head to write data to the recording session using the optimum laser power level.

Preferably, the optical storage medium comprises an information area (such as PMA on a CD, RMD on a −DVD, TOC on a +DVD and the like) storing address data corresponding to the recording session. The optical read/write head further reads the address data from the information area. In general, the optical storage medium may be a CD-R, a CD-RW, a DVD-R, a DVD-RW or a DVD+RW.

### BRIEF DESCRIPTION OF THE DRAWINGS

The present invention can be more fully understood by reading the subsequent detailed description and examples with references made to the accompanying drawings, wherein:

FIG. 1 is a diagram of the system architecture of a conventional WLAN;

FIG. 2 is a flowchart of an exemplary wireless communication connection process according to the invention;

FIG. 3 is a diagram illustrating an exemplary data packet;

FIG. 4 is a diagram illustrating an exemplary first wireless data packet;

FIG. 5 is a diagram illustrating an exemplary second wireless data packet;

FIG. 6 is a system architecture diagram for communication connection via heterogeneous networks according to the first and second embodiments of the invention;

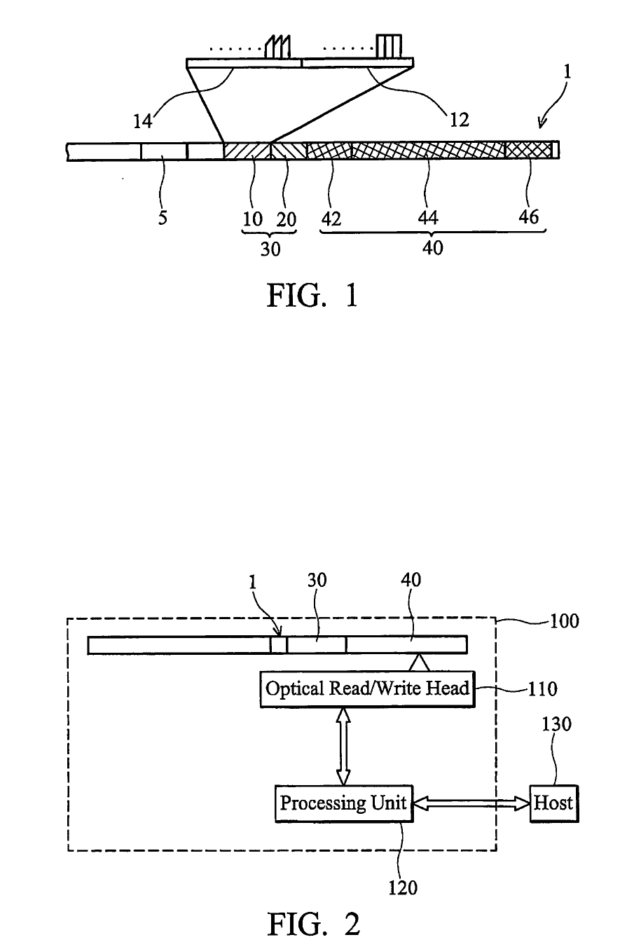

### DETAILED DESCRIPTION OF THE INVENTION

The present invention introduces a novel optimum power calibration (OPC) procedure to record data to an optical storage medium. The optical storage medium may be a CD-R, a CD-RW, a DVD-R, a DVD-RW or a DVD+RW. The novel OPC procedure determines an optimum laser power level utilizing a recording session in a data area instead of a test area in a power calibration area (PCA), with improved optimum power calibration (OPC) accuracy.

FIG. 2 is a system architecture diagram of an optical storage device according to the invention. The optical storage device 100 comprises an optical read/write head 110 and a processing unit 120, a mechanical unit (not shown), a rotation motor (not shown) and a load pallet (not shown). The optical read/write head 110 reads data from an optical storage medium 1 and writes data to the optical storage medium 1.

In one example, the storage medium 1 contains an information area (such as PMA on a CD, RMD on a −DVD, TOC on a +DVD and the like) and a data area. In order to recognize the available space for the next data writing session, the information area stores a number corresponding to a start position of the data area, and a second number corresponding to an end position of the data area. The processing unit 120 directs the optical read/write head 110 to read and write data. The processing unit 120 couples to the optical read/write head 110, acquires the first number to determine the start position of the data area, determines a test position of the data area according to the start position, and performs an OPC procedure to determine an optimum laser power level. In the OPC procedure, the processing unit 120 directs the optical read/write head 110 to write multiple test samples from the test position using various test laser power levels and subsequently reads the test samples with a lower-power reading laser. The processing unit 120 additionally determines the optimum laser power level according to the read results of the test samples.

In another example, the storage medium 1 contains an information area (such as PMA on a CD, RMD on a −DVD, TOC on a +DVD and the like) and a data area. The data area contains a recording session available for data recording. In order to recognize the physical location for the recording session, the information area stores address data corresponding to the recording session. The optical read/write head 110 is configured to write multiple test samples in the recording session using multiple test laser power levels, and reads the test samples with a lower-power reading laser. The processing unit 120 couples to the optical read/write head 110, determines an optimum laser power level according to the read results of the test samples, and directs the optical read/write head 110 to erase the test samples from the recording session and write data in the recording session using the optimum laser power level.

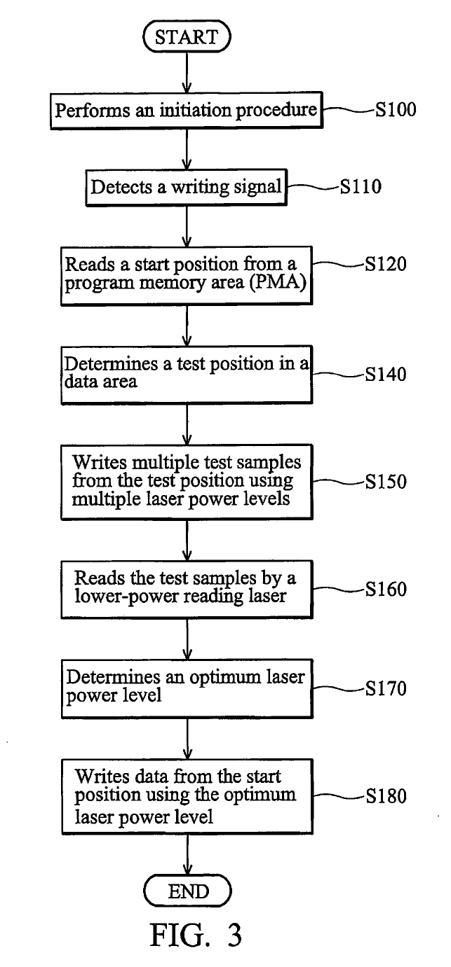

FIG. 3 is a flowchart showing a method of data recording according to the present invention. The process begins in step S100 by performing an initiation procedure after detecting an optical storage medium has been loaded. In step S110, a writing signal is detected.

In step S120, a first number and a second number are read from an information area (such as PMA on a CD, RMD on a −DVD, TOC on a +DVD and the like) in the optical storage medium. The first number corresponds to a start position in a data area, and the second number corresponds to an end position in the data area. The data area between the start position and the end position is available for data recording. In step S140, a test position in the data area is determined according to the start position. The test position may be the start position, or may be located between the start position and the end position.

In step S150, multiple test samples are written from the test position using multiple test laser power levels (preferably 15 test samples are written using 15 test laser power levels). In step S160, multiple data samples are read from the data area by a lower-power reading laser. In step S170, an optimum laser power level is determined according to read results of the data samples. Thus, the optimum laser power level is determined by performing an OPC procedure in a data area instead of the conventional PCA, resulting in improved OPC accuracy. In step S180, data is written from the start position using the optimum laser power level.

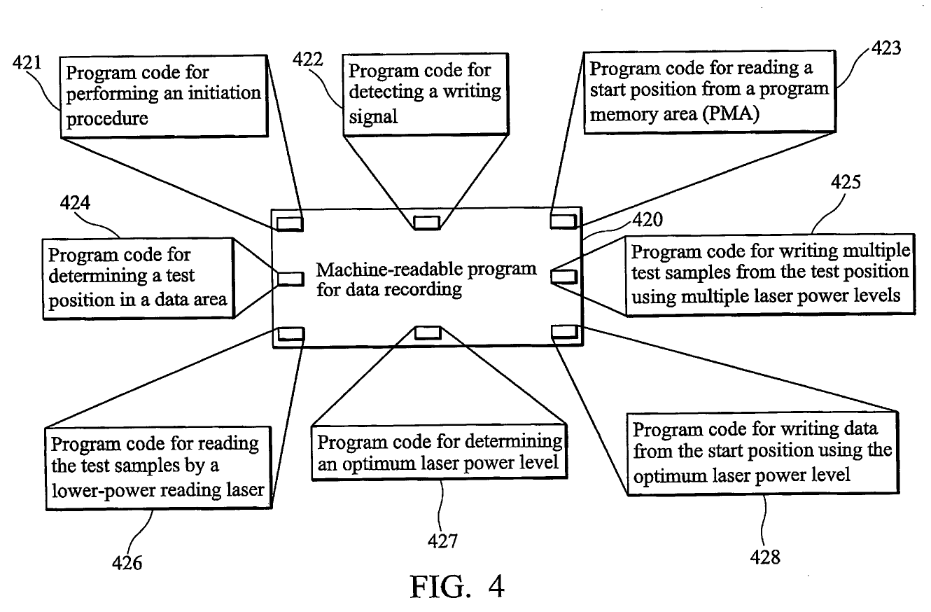

The invention additionally discloses a storage medium as shown in FIG. 4 storing a machine-readable program 420 providing the disclosed method for recording data. The optical storage device 100 includes a non-volatile memory (not shown), such as a ROM, an EEPROM, a flash ROM, or others, storing the machine-readable program 420. The machine-readable program code comprises at least computer readable program code 421 performing an initiation procedure after detecting an optical storage medium has been loaded, computer readable program code 422 detecting a writing signal, computer readable program code 423 reading a first number and a second number from an information area (such as PMA on a CD, RMD on a −DVD, TOC on a +DVD and the like) in the optical storage medium, computer readable program code 424 determining a test position according to the start position, computer readable program code 425 writing multiple test samples from the test position using multiple test laser power levels, computer readable program code 426 reading multiple data samples from the data area by a lower-power reading laser, computer readable program code 427 determining an optimum laser power level according to read results of the data samples and computer readable program code 428 writing data from the start position using the optimum laser power level.

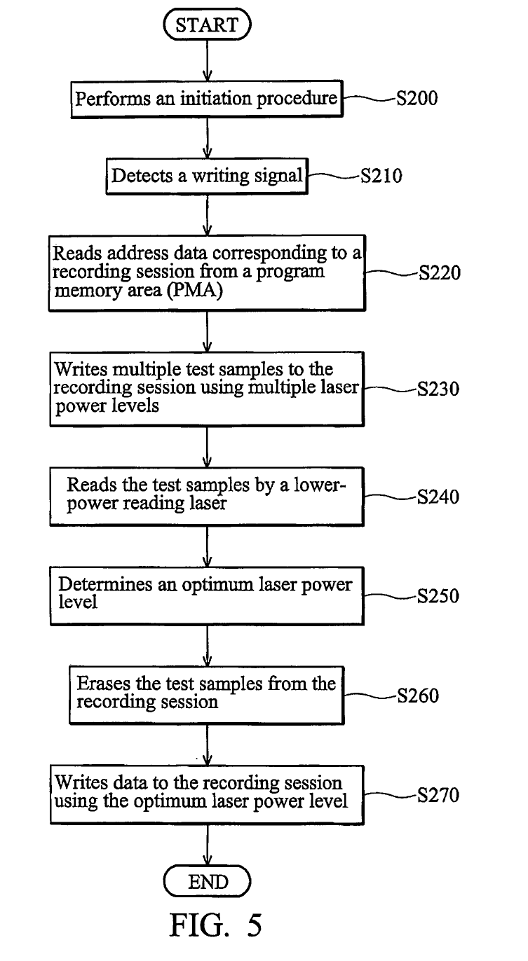

FIG. 5 is a flowchart showing a method of data recording according to the present invention. The process begins in step S200 by performing an initiation procedure after detecting an optical storage medium has been loaded. In step S210, a writing signal is detected. In step S220, address data corresponding to a recording session of the optical storage medium is read from an information area (such as PMA on a CD, RMD on a −DVD, TOC on a +DVD and the like). In step S230, multiple test samples are written in the recording session using multiple test laser power levels. In step S240, multiple test samples are read by a lower-power reading laser. In step S250, an optimum laser power level is determined according to the read results of the test samples. Thus, the optimum laser power level is determined by performing an OPC procedure in a data area instead of the conventional PCA, resulting in improved OPC accuracy. In step S260, the test samples are erased from the recording session. In step S270, data is written in the recording session using the optimum laser power level.

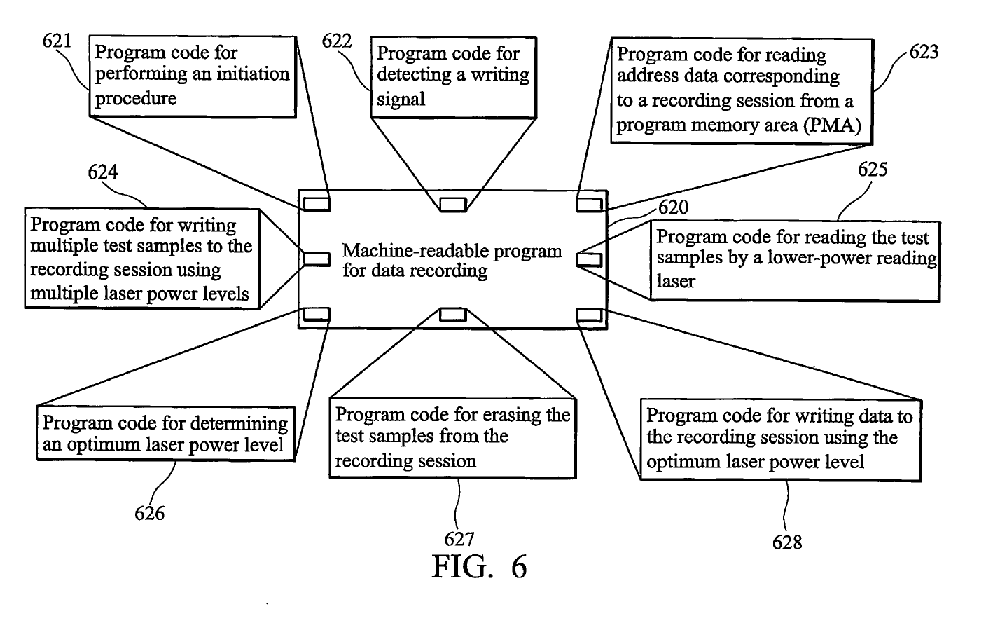

The invention additionally discloses a storage medium as shown in FIG. 6 storing a machine-readable program 620 providing the disclosed method for recording data. The optical storage device 100 includes a non-volatile memory (not shown), such as a ROM, an EEPROM, a flash ROM, or others, storing the machine-readable program 420. The machine-readable program code comprises at least computer readable program code 621 performing an initiation procedure after detecting an optical storage medium has been loaded, computer readable program code 622 detecting a writing signal, computer readable program code 623 reading address data corresponding to a recording session in the optical storage medium from an information area (such as PMA on a CD, RMD on a −DVD, TOC on a +DVD and the like), computer readable program code 624 writing multiple test samples in the recording session using multiple laser power levels, computer readable program code 625 reading multiple test samples by a lower-power reading laser, computer readable program code 626 determining an optimum laser power level according to the read results of the test samples, computer readable program code 627 erasing the test samples the recording session and computer readable program code 628 writing data to the recording session using the optimum laser power level.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

1. A method for recording data to a data area of an optical storage medium, comprising the steps of:
acquiring a start position of the data area for data recording;
determining a test position of the data area according to the start position;
performing an optimum power calibration (OPC) procedure to determine an optimum laser power level for the test position; and
writing data from the start position using the optimum laser power level.

2. The method as claimed in claim 1, wherein the optical storage medium comprises an information area storing a first number corresponding to the start position of the data area.

3. The method as claimed in claim 2 further comprising a step of reading the first number to acquire the start position.

4. The method as claimed in claim 2, wherein the information area comprises a second number corresponding to an end position of the data area, and the test position is located between the start position and the end position.

5. The method as claimed in claim 1, wherein the test position is the start position.

6. The method as claimed in claim 1 further comprising the steps of:
writing a plurality of test samples from the test position using a plurality of test laser power levels;
reading the test samples; and
determining the optimum laser power level according to the read results of the test samples.

7. The method as claimed in claim 5 further comprising a step of generating a writing strategy comprising a laser waveform and the laser power level, according to the read results of the test samples.

8. The method as claimed in claim 1, wherein the optical storage medium is a CD-R, a CD-RW, a DVD-R, a DVD−RW or a DVD+RW.

9. A method for recording data in a recording session of an optical storage medium, comprising the steps of:
writing a plurality of test samples to the recording session of a data area;
reading the test samples;
determining an optimum laser power level according to the read results of the test samples;
erasing the test samples from the recording session; and
writing data to the recording session using the optimum laser power level.

10. The method as claimed in claim 9, wherein the optical storage medium comprises an information area storing address data corresponding to the recording session.

11. The method as claimed in claim 10 further comprising a step of reading the address data from the information area.

12. An optical storage device for recording data in a data area of an optical storage medium, comprising:
an optical read/write head configured to read data from the data area and write data in the data area; and
a processing unit coupling to the optical read/write head, configured to acquire a start position of the data area for data recording, determine a test position of the data area according to the start position and perform an optimum power calibration (OPC) procedure to determine an optimum laser power level.

13. The optical storage device as claimed in claim 12, wherein the optical storage medium comprises an information area storing a first number corresponding to the start position of the data area, and the processing unit directs the optical read/write head to read the first number as the start position.

14. The optical storage device as claimed in claim 13, wherein the information area comprises a second number corresponding to an end position, the test position is located between the start position and the end position.

15. The optical storage device as claimed in claim 12, wherein the test position is the start position.

16. The optical storage device as claimed in claim 12, wherein the processing unit directs the optical read/write head to write a plurality of test samples from the test position using a plurality of test laser power levels and read the test samples. The processing unit additionally determines the optimum laser power level according to the read results of the test samples.

17. The optical storage device as claimed in claim 12, wherein the optical storage medium is a CD-R, a CD-RW, a DVD-R, a DVD−RW or a DVD+RW.
